(19) United States
(12) Patent Application Publication
(10) Pub. No.: US 2003/0206180 A1
(43) Pub. Date: Nov. 6, 2003

(54) Color space rendering system and method

(76) Inventors: Richard L. Ehlers, Park City, UT (US); Jan N. Bjernfalk, Salt Lake City, UT (US)

Correspondence Address: Steve M. Perry, THORPE, NORTH & WESTERN, L.L.P., P.O. Box 1219, Sandy, UT, 84091-1219, US

(21) Appl. No.: 09/972,048

(22) Filed: Oct. 5, 2001

(51) Int. Cl. G09G 5/02

(52) U.S. Cl. 345/604

(57) ABSTRACT

A system and method for combining inputs from differently formatted graphics and video sources to create an electronically displayable image. The system includes at least one generative computer graphics input and at least one digital video input. A color space converter is used for each generative computer graphics input and each digital video input in order to convert each input into a common display format. A blending unit is also included that is coupled to the color space converters. The blending unit blends the common display format from each generative computer graphics input and digital video input. The blended output in the common display format can be stored in the frame buffer.

### SPECIFICATION

1. Field of the Invention

The present invention relates generally to color space conversion for computer graphics systems. More particularly, the present invention relates to color space conversion, blending and storage for computer graphics and video systems.

2. Background

With the increased use of video and generative computer graphics, there is a desire to be able to quickly and easily combine video with computer graphics. Unfortunately, video and generative computer graphics come from data sources that are defined in different color spaces. Video data is typically defined in YCbCr or YUV. The YCbCr color space has a luminance component (Y), a first color difference component (Cb) and a second color difference component (Cr). Generative graphic output is usually defined in the additive scheme of RGB (Red, Green, Blue).

A large part of the problem comes from the video centric community. Groups using video components want the final results to be in YCbCr. This can be a difficult problem because they do not want any color precision lost in any color space conversion that may occur in the system. In order to combine these types of input from different sources, certain problems must be overcome. Particularly, the entire YCbCr color space does not convert to valid RGB values. On the other hand, all RGB values do convert to valid YCbCr values.

### SUMMARY OF THE INVENTION

The invention provides a system and method for combining inputs from differently formatted graphics and video sources to create an electronically displayable image without the loss of critical color information. The system includes at least one generative computer graphics input and at least one digital video input. A color space converter is used for each generative computer graphics input and each digital video input in order to convert each input into a common display format. A blending unit is also included that is coupled to the color space converters. The blending unit blends the common display format from each generative computer graphics input and digital video input. The blended output in the common display format can be stored in the frame buffer.

In accordance with a more detailed aspect of the present invention, a method is provided for blending and storing multiple inputs in a graphics system. The method comprises the steps of receiving at least one generative computer graphics input and receiving at least one digital video input. Another step is applying a color space conversion to each generative computer graphics input and digital video input, in order to convert the generative computer graphics input and the digital video input to a common graphics format. A further step is blending the converted generative computer graphics input and digital video input. An additional step is storing the blended generative computer graphics input and digital video input in the common graphics format.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of an embodiment of a color space conversion system in accordance with the present invention;

FIG. 2 is a flow chart of steps that can be taken in the color space conversion method;

FIG. 3 is a more detailed block diagram of one possible implementation of a color space conversion system.

### DETAILED DESCRIPTION

For purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

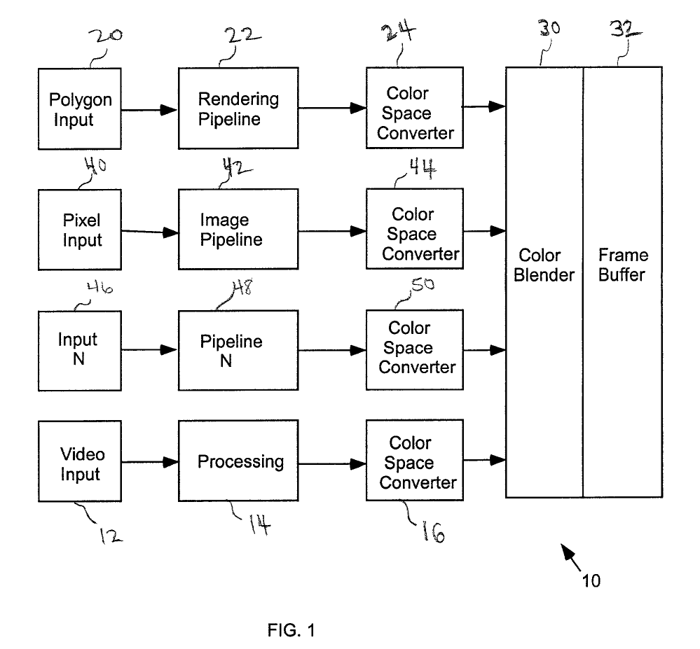

FIG. 1, indicated generally at 10 is a system for combining inputs from differently formatted graphics and video sources to create an electronically displayable image. The system input will be received from two or more types of digital input. In this embodiment, the first input is a digital video input 12 and the second is a generative computer graphics input 20. The video input is generally from a video camera or some other type of optically captured data, which can be processed and filtered accordingly 14. Input can also be received as a digital image, scanned image, a direct write of pixels from a storage disk, over the system bus or from a network (e.g. texture map loading directly into memory.

A plurality of color space converters is also included. Each digital video input 12 is coupled to its own separate color space converter 16. Each generative computer graphics input is coupled to at least one separate color space converter 24 in order to convert the input into a common display format. The generative graphics input 20 can also be processed through a rendering or color pipeline 22.

A blending unit or color blender 30 is coupled to the color space converters 16, 24, 44, 50. The blending unit blends the common display format from each generative computer graphics input and digital video input before it is stored in the frame buffer. In addition, there may be a general pixel input 40 for special purposes such as overlays, etc. that is separately processed in an image pipeline 42 and converted with its own color space converter 44. There may be any other number of inputs 46 and processing pipelines 48 as needed. A color space converter 50 can also convert any additional inputs.

The common display format is important because one advantage of the invention is that it avoids restricting the system in terms of what pre-configured pixel data storage format can be used. The system can store the intermediate or final results in any color space: RGB, YCbCr, YUV, HSV, etc. For example, when dealing with video centric applications the system can store all the data in YCbCr. Generative graphics data (usually RGB) will then be color space converted where appropriate before blending with existing graphics and video pixel data and stored in pixel memory. What is important is that the multiple types of data are all converted and blended so that they can be stored in a common display format in the frame buffer. The invention combines inputs from differently formatted graphics and video sources to create an electronically displayable image without the loss of critical color information.

Besides generative graphics, input data can come from many other sources, such as video cameras, camcorders, texture memory, videotape, etc., where each source can have different data formats. The point at which the color space conversion occurs can vary and will vary with different implementations of this invention. These conversion points can be in the software prior to giving the input to the hardware, within the rendering setup engine, or in the blender. Accordingly, the conversion will take place prior to the output of the blending unit. This conversion before blending allows data of various formats to be blended together in a single blended pixel. In contrast to the prior art, the blended pixel or single format pixel can then be stored in the frame buffer. It should also be realized that the invention can use more than one blending unit, where each blending unit can receive two or more inputs to blend as necessary.

There are different implementation possibilities for the invention depending on user requirements and the software or hardware available to implement the invention. One possible solution is a color space conversion to put the results in temporary storage (e.g. texture memory), which is then output back to the texture engine or a display. Another possible configuration is to have the color space conversion done at the color blender's output time with no intermediate storage.

To try to solve the problem of multiple input formats, some prior art systems have extended the data range of RGB values stored in the pixel memory. This only allows two formats to coexist and it does not address storage and blending problems. The present invention has the advantage over the extension method that it can store multiple color spaces. Further, it keeps the data stored within the range of 0 to 1.

Some other systems allow various data formats to be stored separately in the pixel buffer, and also allow the conversion of the output data to the appropriate device (RGB monitor, TV monitor, etc.). However, these types of systems do not allow input data of different formats to be blended together within a single pixel. The advantage of the present invention over a combination storage system is the ability to accept data from different formats and sources and to blend such data into single pixels that can be stored in the frame buffer.

The invention is also a method for controlling what is stored in pixel memory to represent the image data. A current practice is to store RGB format data when describing systems with generative graphics or a combination of video and generative graphics. This invention is the application of additional steps applied in a unique way to solve the color space dynamic range issue. As such, there is great flexibility in how the solution is implemented. This allows for trade-offs to be made due to performance and cost issues for a particular product.

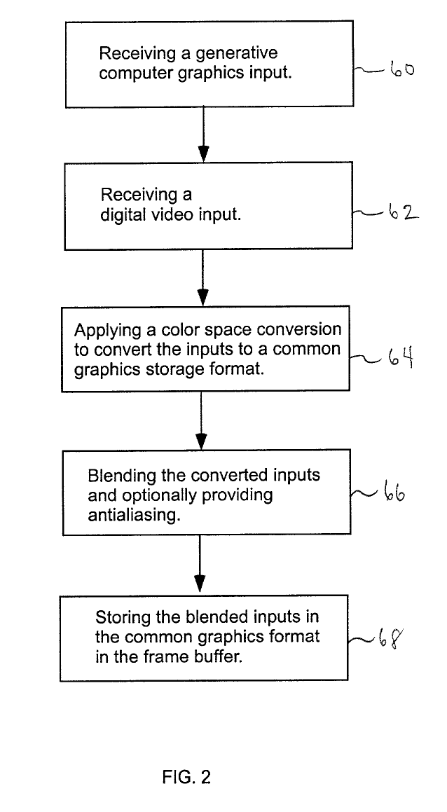

FIG. 2 illustrates a method that can be used in the system of FIG. 1. The method provides the steps for blending and storing multiple inputs in a graphics system. The method comprises the steps of receiving at least one generative computer graphics input 60 and receiving at least one digital video input 62. Of course, other types of digital input can be received such as a static overlay or some other type of graphic input. Another step is applying a color space conversion to each generative computer graphics input and digital video input, in order to convert the generative computer graphics input and the digital video input to a common graphics format 64. A further step is blending the converted generative computer graphics input and digital video input and optionally providing antialiasing 66. The blending that takes place can include transparency type blending, edge blending, filtering, etc. An additional step is storing the blended generative computer graphics input and digital video input in the common graphics format in the frame buffer 68.

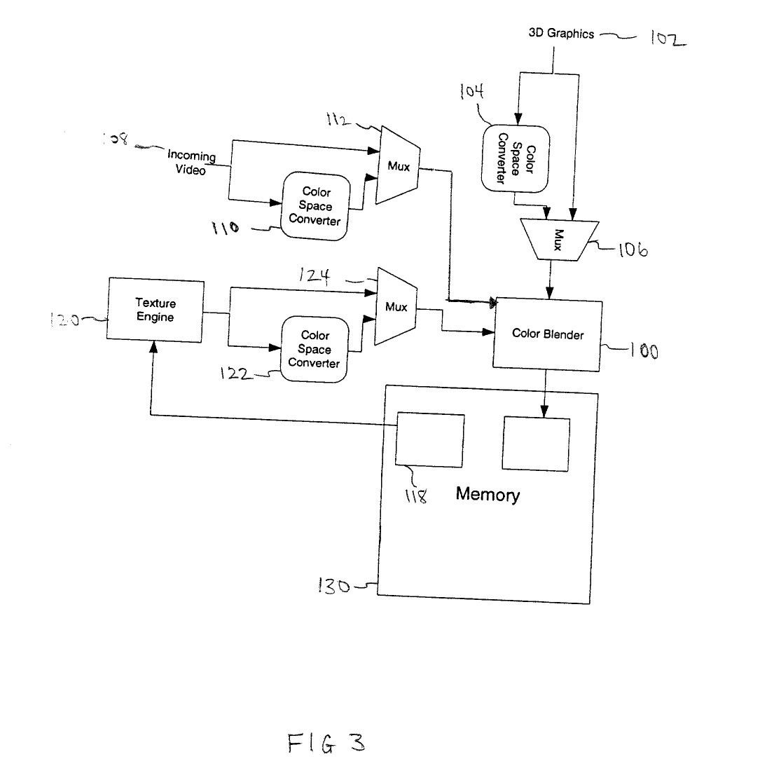

FIG. 3 aids in illustrating an alternative embodiment of the invention. In this embodiment, each input enters into a single color blender 100 or blending unit. More specifically, a generative graphics input or 3D graphics input 102 is converted into a common display format in a color space converter 104 and the signal also passes through a multiplexer (MUX) 106. The MUX is used when an input does not need to be converted or if the input is already in the proper format. In other words, the MUX can select between converting and not converting the input. An incoming video signal 108 is also converted through its own color space converter 110 and then the signal passes through a MUX 112. A third signal is received from a texture engine 120 that processes textures stored in allocated texture memory 118. The texture signal is processed by the color space converter 122 and passes through a MUX 124. All three (or more) input signals are processed by the color blender in the same storage format or common graphics format. The blended pixels are stored in the frame buffer or memory 130. Since there is only one format to be stored and the inputs have been blended together for the frame or each pixel in the frame, this reduces the storage requirements. In addition, a uniform output is produced from the frame buffer and no conversion is required at the output from the frame buffer.

An example embodiment of the present system will now be described. The embodiment describes how the invention handles a weather broadcast of a hurricane. The following can be the inputs to the system:

1. Live video from a ground camera showing the actual hurricane. This is used as the background and is in YCbCr color space.

2. Live video from a camera shot of the meteorologist in the studio. This data is in the YCbCr color space.

3. Generative graphics of a globe. This data is in the RGB color space.

4. Satellite cloud photographic data to be used as texture to be applied to globe. This data is in YCbCr format.

All the data for 1, 2 and 4 are fed in and stored in memory in their native color space (i.e., YCbCr).

The following steps can be used to generate the frame output that shows the meteorologist standing in front of the live video of the occurring hurricane and pointing at the globe to show the location of the hurricane and the associated clouds.

1. The satellite video of the hurricane is received as input and converted if necessary.

2. The video of the meteorologist is then blended pixel by pixel with the satellite image using a chromakey or “blue screen” process.

3. The globe is rasterized in RGB using lighting to show the current location of sun.

4. Just prior to the application of satellite cloud data in a texturing operation, the RGB color of the globe for each pixel is converted to YCbCr before blending.

5. Texturing blending occurs to put the clouds on the globe while keeping the lighting effects.

6. All the inputs can then be blended into memory for the final image.

7. Repeat steps 3-6 for all pixels in the globe.

8. Output the final image. If the image will be recorded on tape or live broadcast that requires YCbCr, nothing is done. If the image is going to be sent to a computer monitor that requires RGB, then a color space conversion is performed either prior to or as the data is sent to the computer monitor.

It is to be understood that the above-described arrangements are only illustrative of the application for the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in implementation, form, function and manner of operation, assembly and use may be made, without departing from the concepts of the invention as set forth in the claims.

What is claimed is:

1. A system for combining inputs from differently formatted graphics and video sources to create an electronically displayable image, comprising:
(a) at least one generative computer graphics input;
(b) at least one digital video input;
(c) a plurality of color space converters, wherein each generative computer graphics input and each digital video input is coupled to at least one separate color space converter in order to convert each input into a common display format; and
(d) a blending unit, coupled to the color space converters, to blend the common display format from each generative computer graphics input and digital video input.

2. A system as in claim 1, further comprising a frame buffer for storing blended common display formats.

3. A system as in claim 1, wherein the at least one generative computer graphics input is in RGB (Red, Green, Blue) format.

4. A system as in claim 1, wherein the at least one digital video input is in a video format selected from the group of video formats consisting of YCrCb, YUV, and HSV.

5. A system as in claim 1, wherein the common display format is a format selected from the group of formats consisting of RGB, YCrCb, YUV, and HSV.

6. A method for blending and storing multiple inputs in a graphics system, comprising the steps of:
(a) receiving at least one generative computer graphics input;
(b) receiving at least one digital video input;
(c) applying a color space conversion to each generative computer graphics input and each digital video input, in order to convert the generative computer graphics input and the digital video input to a common graphics format;
(d) blending the converted generative computer graphics input and digital video input to; and
(e) storing the blended generative computer graphics input and digital video input in the common graphics format.

7. A method as in claim 6, further comprising the step of displaying the blended generative computer graphics input and digital video input.

8. A method as in claim 6, further comprising the step of storing the blended generative computer graphics input and digital video input in a frame buffer in the common graphics format.

9. A system as in claim 6, wherein the step of receiving at least one generative graphics input in a first graphics format, further comprises the step of receiving at least one generative computer graphics input in RGB (Red, Green, Blue) format.

10. A system as in claim 6, wherein the step of receiving at least one digital video input, further comprises the step of receiving at least one digital video input is in a video format selected from the group of video formats consisting of YCrCb, YUV, and HSV.

11. A system as in claim 6, further comprising the step of defining the common graphics storage format as a format selected from the group of formats consisting of RGB, YCrCb, YUV, and HSV.

12. A color blending system for electronically displayable images, comprising:
(a) a generative computer graphics input having graphics input data in a pre-defined computer graphics format;
(b) a digital video input having video input data in a pre-defined video format;
(c) a color space converter, coupled to the generative computer graphics input and digital video input, to convert video input data from the generative computer graphics input and digital video input into a common display format before the graphics input data and video input is stored in the frame buffer; and
(d) a blending unit, coupled to the color space converter, to blend the converted input data from the generative computer graphics input and digital video input.

13. A system as in claim 12, further comprising a frame buffer for storing blended input data.

14. A system as in claim 12, wherein the at least one generative computer graphics input is in RGB (Red, Green, Blue) format.

15. A system as in claim 12, wherein the at least one digital video input is in a format selected from the group consisting of YCrCb, YUV, and HSV.

16. A method for combining inputs from differently formatted graphics and video sources for blending and storage in a frame buffer, comprising the steps of:
(a) receiving at least one generative graphics input in a first graphics format;
(b) receiving at least one digital video input in a video graphics format;
(c) applying a color space conversion to each generative graphics input and digital video input in order to convert each input to a common format;
(d) blending the generative graphics input and digital video input in a common format into one pixel; and
(e) storing the converted inputs that have been combined into one pixel in the frame buffer.

17. A method as in claim 16, further comprising the step of storing blended common formats in a frame buffer.

18. A system as in claim 16, wherein the step of receiving at least one generative graphics input in a first graphics format, further comprises the step of receiving at least one generative computer graphics input in RGB (Red, Green, Blue) format.

19. A system as in claim 16, wherein the step of receiving at least one digital video input, further comprises the step of receiving at least one digital video input is in a video format selected from the group of video formats consisting of YCrCb, YUV, and HSV.

20. A system as in claim 16, further comprising the step of defining the common display format as a video format selected from the group of video formats consisting of YCrCb, YUV, and HSV.
